(19) United States
(12) Patent Application Publication
(10) Pub. No.: US 2020/0104945 A1
(43) Pub. Date: Apr. 2, 2020

(54) SYSTEM AND METHOD FOR CURATION OF NOTABLE WORK AND RELATING IT TO INVOLVED ORGANIZATIONS AND INDIVIDUALS

(71) Applicant: Shocase, Inc., San Francisco, CA (US)

(72) Inventors: Ronald P. Young, Mill Valley, CA (US); David Anthony Burgess, Menlo Park, CA (US); Robert Walter Kerns, Corte Madera, CA (US); Peter Rugg, New York, NY (US)

(73) Assignee: Shocase, Inc., San Francisco, CA (US)

(21) Appl. No.: 16/701,125

(22) Filed: Dec. 2, 2019

Related U.S. Application Data
(63) Continuation of application No. 15/057,371, filed on Mar. 1, 2016, now abandoned.
(60) Provisional application No. 62/126,655, filed on Mar. 1, 2015.

(51) Int. Cl. G06Q 50/00; G06Q 10/06

(52) U.S. Cl. CPC G06Q 50/01; G06Q 10/06398

(57) ABSTRACT

A method for use in populating a user profile comprises the steps of: determining that a first person within a database of people is associated with a given award within a database of awards; determining that a first project within a database of projects is associated with the given award within a database of awards; and populating the profile for the first person with information associated with the first project.

### CROSS-REFERENCE TO RELATED APPLICATIONS

This Application claims the benefit of U.S. Provisional Patent Application Ser. No. 62/126,655, filed Mar. 1, 2015, entitled “System and Method for Curation of Notable Work and Relating It To Involved Companies and Individual on a Social Network,” which is hereby incorporated by reference herein in its entirety for all purposes.

This Application is also related to U.S. application Ser. No. 14/626,012, filed Oct. 6, 2014, entitled “System and Method to Provide Collaboration Tagging for Verification and Viral Adoption,” and to U.S. application Ser. No. 14/507,003, filed Feb. 19, 2015, entitled “System and Method to Provide Pre-Populated Personal Profile in a Social Network,” which are hereby incorporated by reference herein. This application is further related to U.S. Provisional Patent Application Ser. No. 62/210,335, filed Aug. 26, 2015, which is hereby incorporated by reference herein.

### FIELD

The present invention applies generally to computer software, and more particularly to Internet software that further drives social networking applications.

### BACKGROUND

In computer and database systems an efficient method of creating a user-profile and building up an online presence is important in a business environment. There exists prior art in the nature of methods for the automated generation and population of user-profiles in computer systems with varying degrees of input from the user. However, people involved in notable work are often busy people and such systems that search for related data after the user has registered as a member of a network system does little to enhance his or her user experience.

### SUMMARY

One aspect includes a method for use in populating a user profile. The method includes the steps of: determining that a first person within a database of people is associated with a given award within a database of awards; determining that a first project within a database of projects is associated with the given award within a database of awards; and populating the user profile for the first person with information associated with the first project.

Another aspect includes a system for use in populating a user profile. The system includes at least one storage medium comprising a database of people, a database of awards, and a database of projects. The system also includes at least one server coupled to the storage medium. The server is operative: to determine that a first person within the database of people is associated with a given award within the database of awards; to determine that a first project within the database of projects is associated with the given award within the database of awards; and to populate the profile for the first person with information associated with the first project.

A further aspect includes a non-transitory storage medium having software embodied therewith for use in populating a user profile. The software comprises software configured: to determine that a first person within the database of people is associated with a given award within the database of awards; to determine that a first project within the database of projects is associated with the given award within the database of awards; and to populate the profile for the first person with information associated with the first project.

### BRIEF DESCRIPTION OF THE DRAWINGS

The following drawings are presented by way of example only and without limitation, wherein like reference numerals (when used) indicate corresponding elements throughout the several views, and wherein:

FIG. 1 conceptually illustrates exemplary databases of awards and people gleaned from public website data;

FIG. 2 conceptually depicts how data is run through algorithms to automatically create populated projects, in an exemplary methodology according to an embodiment of the invention;

FIG. 3 shows preliminary information associated with the awards being pulled from an award and tagged to a project, according to an embodiment of the invention;

FIG. 4 shows how the algorithms can use the databases and preliminary award information to pull-up a client to be tagged to a project, according to an embodiment of the invention;

FIG. 5 shows how the algorithms can use the databases and preliminary award information to pull-up a possible collaborator to be tagged to a project, ready to be offered as a project to that collaborator when he or she joins the website, according to an embodiment of the invention;

FIG. 6 shows how the algorithms can use the databases and preliminary award information and scan through existing projects to pull-up a possible collaborator to be tagged to a project, ready to be offered as a project to that collaborator when he joins the network, according to an embodiment of the invention;

FIG. 7 shows initial and auto-curated data now associated with an award-winning project, according to an embodiment of the invention; and

FIG. 8 shows a flow chart of an exemplary sign-on procedure within a system, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present disclosure will be described herein in the context of illustrative methods and apparatus for use in populating a user profile in a manner which facilitates social networking applications. It is to be appreciated, however, that the specific embodiments and/or methods illustratively shown and described herein are to be considered exemplary rather than limiting. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Embodiments of the present invention may be used for populating, storing, or retrieving a user profile in any digital or similar network. Embodiments of the present invention may be implemented as a system for social networking and/or social collaborating. Social networks are systems that permit users to become members and as members to utilize the system to socialize with other member users. This system may be an Internet site, website, application, software or more, and might be on a computer, smart phone, tablet or other user device and may be published in whole or in part or in summary in the system.

Embodiments of the present invention may also include a method of automatically curating data to pre-load a network with public information and using algorithms to identify people and entities that are associated with that information. Embodiments of the invention may provide a unique system that allows users of a social network website deploying the system to sign-on and become registered users, create a profile and create at least one project efficiently and in the fastest possible time. Users may be presented with pre-loaded data that appears to be related to them or a related company and the opportunity to accept such curated data as part of their personal profile.

In one or more embodiments of the invention, digital curation is applied to interaction with social media including compiling digital images, web links and movie files. It establishes, maintains and adds value to repositories of digital data for present and future use. Enterprises are beginning to utilize digital curation to improve the quality of data within their operational and strategic processes.

Because it can often take any one user a vast period of time to finish a complete and relevant profile, an embodiment of the present invention curates significant achievements and notable works in business, sport, entertainment, and leisure activities, thereby making it easier for a potential new users to join a social network system. An embodiment of the present invention automatically curates data to pre-load a network database with public information, noting important achievements and the people who are associated with them and using algorithms to approximate their email address and any other useful data such as responsibilities and position as related to the achievement. Individuals may be solicited to join the social network based on the curated data, and new users are presented with the opportunity to accept curated data as part of their user profile when they sign on and become member of the social network site. The new user can verify and amend the data as necessary for his certification. A plethora of data is curated from all over the broad digital information highway and pooled into databases that include notable award-winning achievements and directories of people and entities related to them. This data can be worked through a system of algorithms to further enhance its value by associating key people and companies who were involved, and identifying expected or anticipated email addresses.

An embodiment of the invention may include a method of capturing award data including the people, organizations, and events or projects for which the awards are given, and populating databases of people, projects, and their related organizations, through which relationships can be identified for purposes of preliminary population of user profiles in a network, subject to confirmation and approval. An embodiment may include pre-loading of award-winning projects on the system and associating it with the awardee and his colleagues and collaborators, the brand, team, squad or event, the sponsor, owner, client, customer, beneficiary, organizing authority or firm. When any of the people or entities related to the achievement joins the social network, the project is then presented to him and can be either accepted (or rejected) as his project and can be associated with his user profile. If data is not already on the site then it can come from publicly accessible sources. An embodiment may be utilized in conjunction with concierge staff members who are available at any time to help complete a new user profile by finding detailed public information that may enhance the user's personal profile. In some embodiments leading figures in certain targeted areas of interest are interviewed by concierge members who can import instant profiles, scan databases for award winning output and populate candidates' profiles with projects and collaborators based on public award reports. The candidate need only review, change the password, and click the invite buttons on list of identified collaborators.

An embodiment of the present invention may include a system that, through searches of appropriate public digital or digitized analog information curates databases of notable achievements and endeavors that may be related to the purposes of certain social networks. The system interprets and analyzes such achievements and endeavors in order to identify all people, firms, teams, brands, agencies, organizations, groups and figures who are related to the said achievements and endeavors, then stores these data in additional databases. The system utilizes additional tools and algorithms to identify email addresses, phone numbers, addresses, or other personal identifiers of the people and entities related to the said achievements and endeavors. The system links data on awards, superlatives, and other measures of success to said achievements and endeavors. The system provides to any person, firm, team or other organization who is a user of a social network the opportunity to claim, review, amend and verify the achievement or endeavor and related collaborators as part of his or its personal profile on the social network.

Embodiments of the present invention provide significant technical advantages relative to the prior art. For example, there may be very rich databases of information available which are better and more valuable than those available in the prior art. Embodiments of the present invention include a method of automatically curating data to pre-load a social network system with public information, further enhancing that data by associated key people with it and presenting them with the opportunity to accept pre-loaded data as part of their profile when they sign on and become member of social network site. In comparison to the lengthy period that can often be required to complete even a basic online profile, an embodiment of the present invention advantageously enables candidates of a social website to register and have a substantial online presence in the fastest time and most efficient manner.

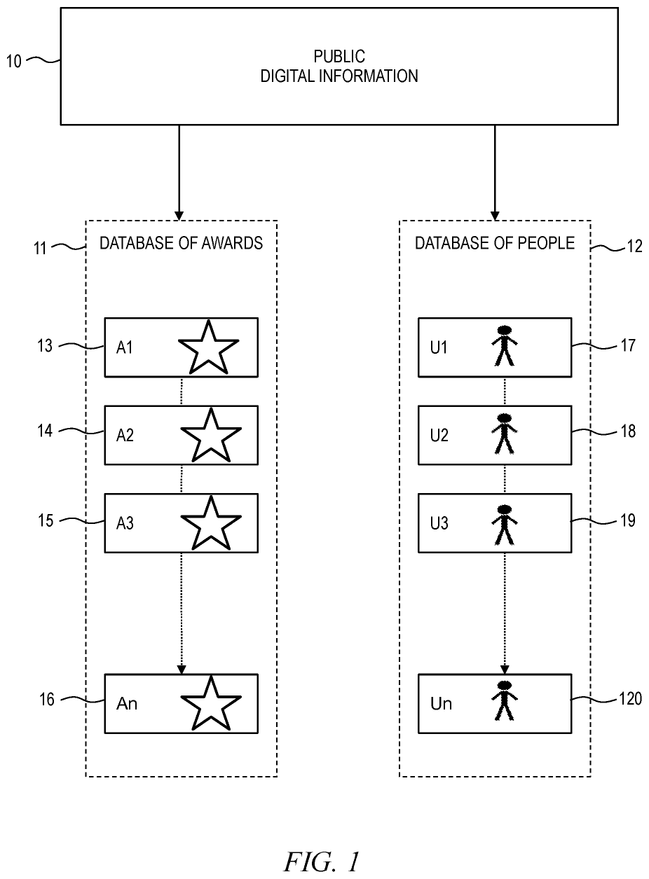

FIG. 1 shows a number of databases that have been created from scanning through a plethora of pertinent web sites all over the Internet, paper archive and other sources (digital and/or analog). These sources 10 have yielded a database of Awards 11 and a database of People 12. The Awards database 11 contains many thousands of public awards including award A1 13, award A2 14, and award A3 15 through many thousands more all the way to award An 16. Likewise, the database of people 12 contains many thousands of people in the marketing and advertising industry including Person U1 17, Person U2 18, Person U3 19, all the way to Person Un 120. These databases are stored on digital media, drives, servers, and digital storage devices of diverse nature. They may be accessed by computers, mobile devices, and other appliances with digital search and display capabilities. Together, these media and digital access devices can be linked into a system that can operate the methods present in this invention.

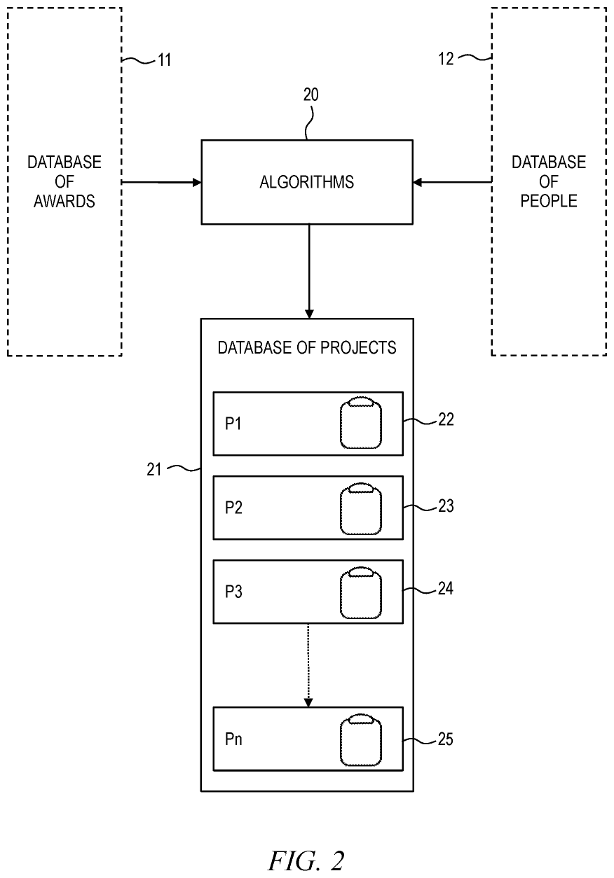

FIG. 2 shows how the databases 11 and 12 are run through algorithms 20 to automatically create a database of projects 21 for the many notable achievements. The digital record, image or video of each of a vast number of award-winning endeavors is loaded onto the system. Shown are a selection of such projects P1 22, P2 23, P3 24 and on to Pn 25. Each project can then be associated with as many of the collaborating team members as can be identified from the public award information. When any of those collaborating team members joins a social network deploying the system and ready to access the database of projects, the new user is offered pre-posted additional projects to supplement in his personal profile based on any match of his personal profile information and the databases of people and projects associated with awards. The database of projects 21 includes both auto-curated and user-created projects. Once a user-created project is in and known to the system, when it is known from public information that a new award for has been announced for such user, then the automatic curation system and/or the concierge team may curate the award details and the system will alert existing users who may have collaborated on the award winning project to the opportunity for an update to their profiles with that new award information.

Although the present application primarily describes illustrative embodiments associated with marketing and/or advertising, the present invention is not limited to these embodiments. Rather, one skilled in the art would recognize that principles of the present invention may be applied to any professional and/or recreational pursuit in which one's achievements may be recognized, including but not limited to competitive activities where one may be recognized as being the best. Examples of other fields to which principles of the present invention may pertain include, but are not limited to, entertainment, movies, sports, live performance, art, and debate. Likewise, one skilled in the art would understand that a project should be broadly construed to encompass any activity and/or creation for which an award may be given. Besides the marketing and advertising campaigns discussed below, other exemplary projects may include athletic contests (e.g., races), movies, gourmet cooking, and/or philanthropic pursuits.

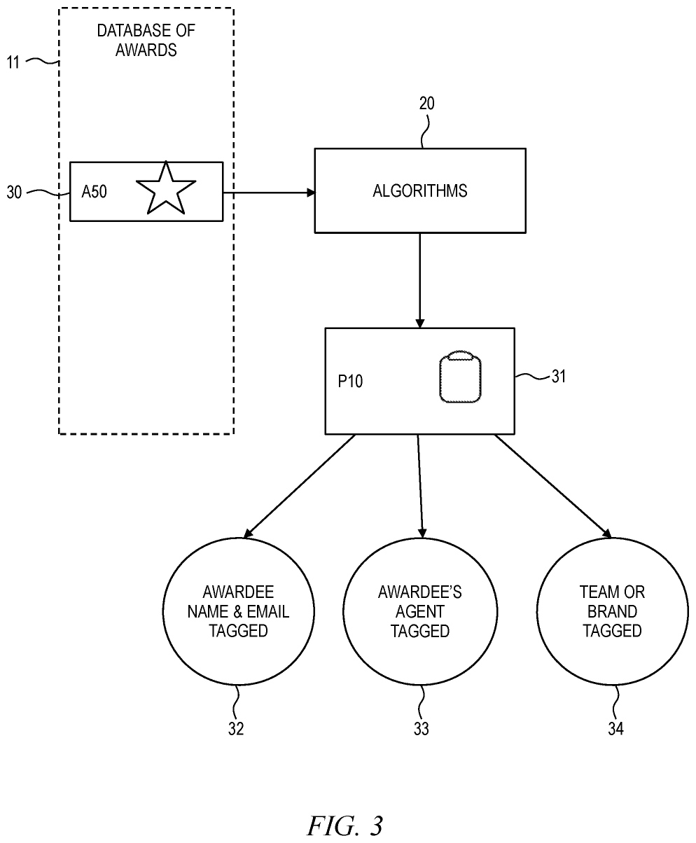

FIG. 3 shows an example of a typical award A50 30 which is stored in the awards database 11. This award 30 is fed through one or more algorithms 20 to create a project P10 31. Some initial attribute details that are already associated with the award from the original database are tagged. These can include the person to whom the award was given 32 (identified by name and email), the advertising firm and/or marketing agent the awardee worked for 33, and the brand for which the advert was made 34. Using this information, some other related data such as an alternate email address for the awardee, could be found via the People database 12. When that person signs-on with the appropriate email address, then that project has been auto curated and is available in the person's profile with a banner that asks for confirmation of ownership of or association with it. Selecting the yes button means that it becomes automatically a part of his profile. In a user's personal profile, the value of the award can be highlighted thus helping an awardee who is a user to stand out among many other network users.

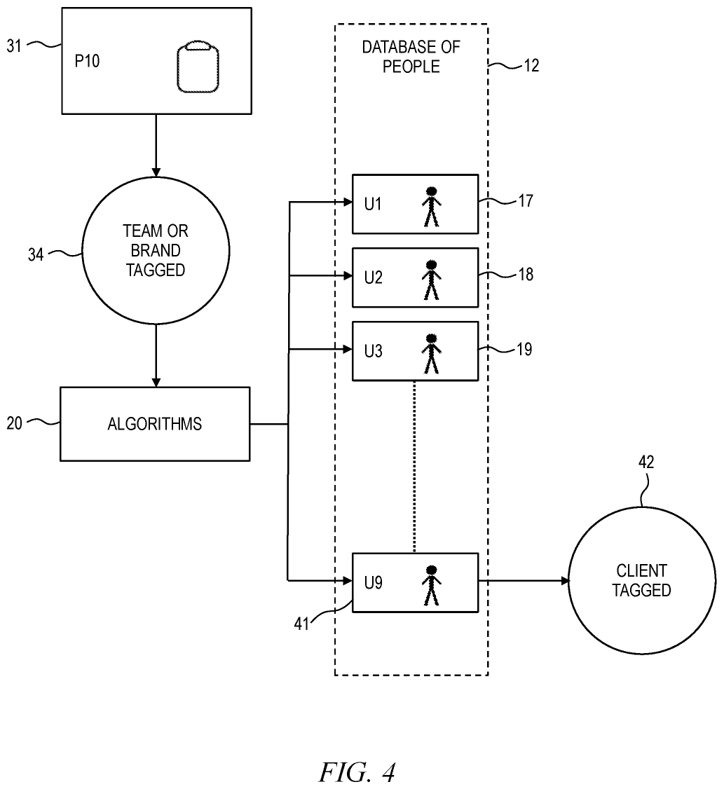

FIG. 4 shows how the Project P10 31 and specifically its brand information 34 can be used to identify another associated person or user. This time the algorithms 20 search the database of people 12 through a number of irrelevant people 17, 18, 19 until it finds person U9 41 who is the marketing director or other senior officer (e.g., president, vice-president, director, producer, manager, general manager, coach, agent, etc.) of the entity that the project is about (e.g., the brand promoted by an advertisement, such as a film or sports team). This person is then tagged to the Project P10 31 as, for example, its client 42. By way of an example, if the award was for an advert for a new design of tennis racket, then by knowing the brand from the original award data, the marketing director of that brand could be identified and automatically curated into the project as the client.

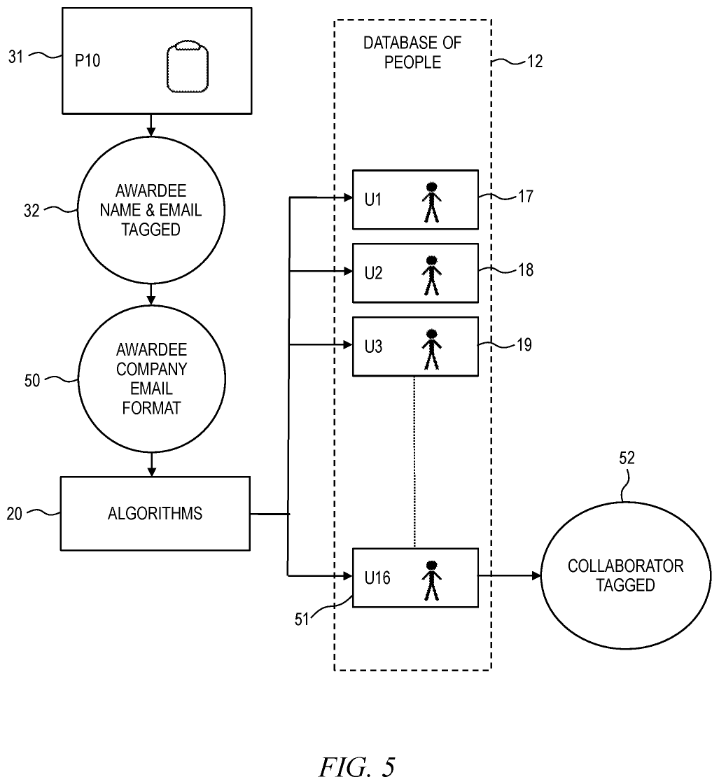

FIG. 5 shows how another collaborator 52 on the project can be detected and auto-curated to the project P10 31. The awardee's company email format 50 is inferred by an algorithm that evaluates the awardee's email address 32 at the company. Using this, the algorithm 20 searches for other people in the database 12 with similar email addresses. Of the many people in the database including 17, 18 and 19 it finds that there is another person U16 51 who works at the same company. That person is tagged as a possible collaborator 52 and the system can offer this project to them as part of their profile when they join the social network.

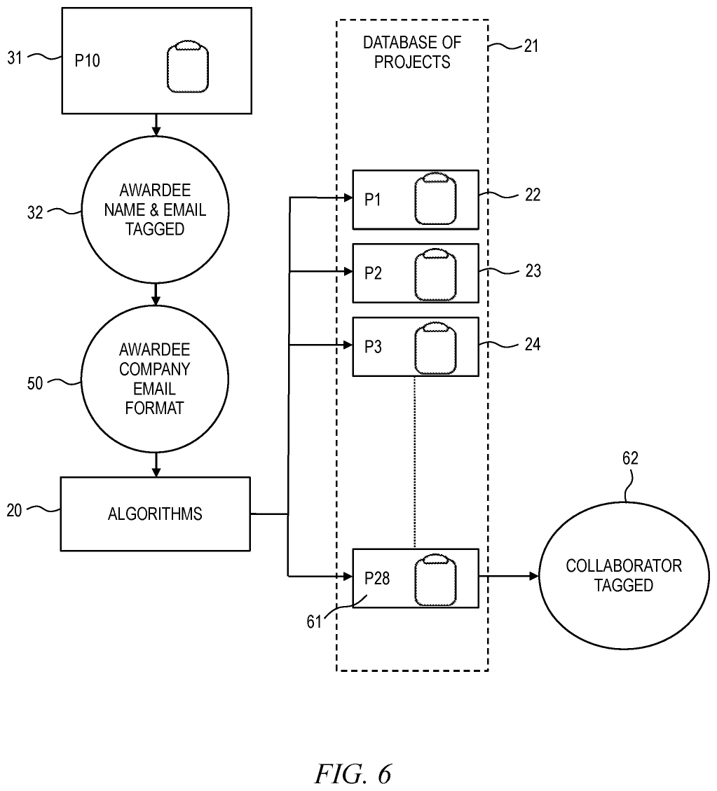

FIG. 6 shows among the projects 22, 23, 24 in the database 21 is a project P28 61 that has been created by an existing social network member. As before, the system knows from its auto-curated project P10 31 the form of the firm's email 50. Using its algorithms to search the database 21 the system find that the creator of project P28 61 has tagged a person (including his name and email address) at that company 50 as a collaborator on project P28 61. That collaborator 62 can therefore be tagged as a possible collaborator on the award winning project 31 and once again the system can offer this project to them as part of their profile when they join the social network. The person 62 might get an email notice or invite from the social network and might not ever register but the site knows he exists and is connected with that project.

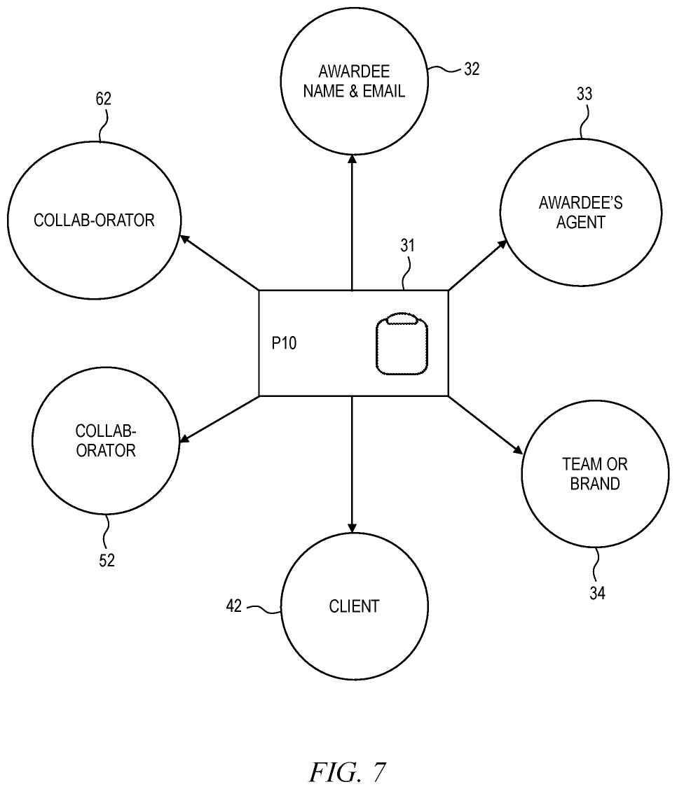

FIG. 7 shows the information now tagged to the Project P10 12 having been run through the algorithms. Everything known about the project has been attached. It has been associated with as many of the collaborating team members as can be identified from the public award information. Then as soon as one of those collaborators joins the network it is offered to the new user as a pre-posted additional project in his profile, subject to the new user's confirmation that he or she was indeed involved. In the example shown here the award P10 31 is now associated with the awardee name and email 32, advertising firm and/or marketing agent 33, brand 34, client 42, and collaborators 52 and 62.

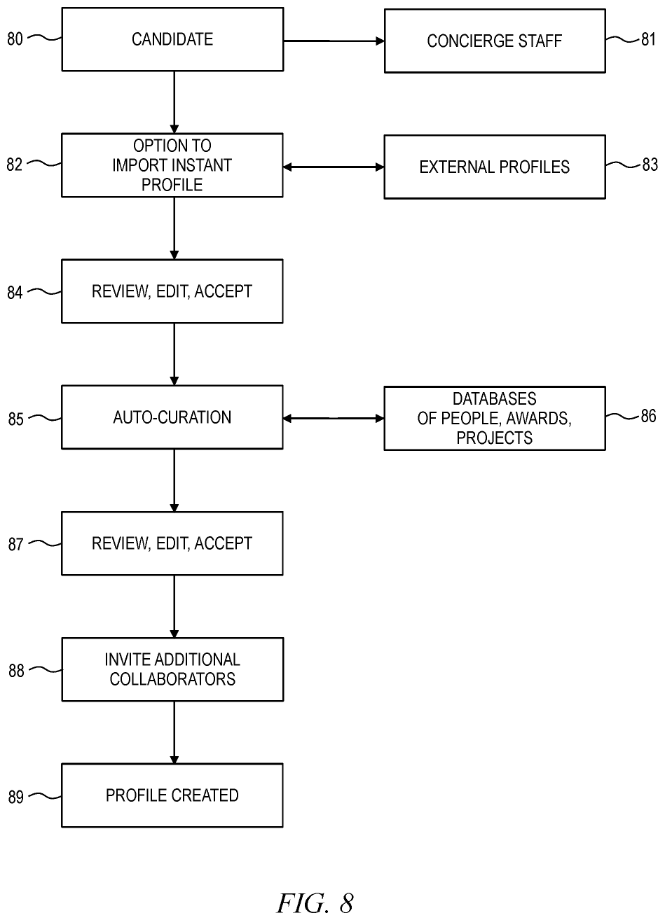

FIG. 8 shows a flow chart of a new user signing-on to the social network and creating a profile using automatic curation of projects and instant-profile. In certain embodiments, a candidate user may be solicited to accept his award winning project on a social network site. In another embodiment, a new employee of a company may wish to publically display his work and achievements accomplished while with another employer.

The candidate 80 can at any time defer to a concierge staff member 81 to assist with the sign-on procedure. The first thing that is offered to a candidate is the option 82 to import an instant profile which pulls in information from any sites that might have a profile 83 defining the candidate's 80 work in relevant industry (e.g., marketing or entertainment). After the candidate completes review, edit and chooses to accept or decline this profile 84, the auto-curation process 85 will pull-in all projects associated with the awards that may be related to the candidate 80 based on algorithmic evaluation of his initial sign-in information such as his email address. The auto-curation process 85 may access databases 86 of people, awards, and/or projects. The candidate is then given the option 87 to review, edit, and accept or decline these projects. The candidate can then invite 88 additional collaborators on these and other projects. The initial profile is then complete 89, though additional projects may subsequently be added to the profile, such as when the candidate 80 is named by another user as a collaborator in another project and the candidate 80 confirms his collaboration in the other project, as discussed above.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for use in populating a user profile, the method comprising the steps of:
determining that a first person within a database of people is associated with a given award within a database of awards;
determining that a first project within a database of projects is associated with the given award within a database of awards; and
populating the profile for the first person with information associated with the first project.

2. The method of claim 1, wherein the profile for the first person comprises a newly-created social media profile.

3. The method of claim 1, wherein the first person comprises an awardee of the given award.

4. The method of claim 1, wherein the database of projects is automatically created using the database of awards and the database of people.

5. The method of claim 1, wherein the database of awards and the database of people are automatically created by scanning through one or more public information sources.

6. The method of claim 1, further comprising determining that a second person within the database of people is associated with the first project.

7. The method of claim 6, wherein populating the profile for the first person with information associated with the first project comprises allowing the first person to confirm or deny that the second person is associated with the first project.

8. The method of claim 6, further comprising populating a profile for the second person with information associated with the first project.

9. The method of claim 6, wherein populating the profile for the second person with information associated with the first project comprises allowing the second person to confirm or deny that the second person is associated with the first project.

10. The method of claim 6, wherein determining the second person associated with the first project comprises the steps of:
determining a brand associated with the first project; and
using the brand to search the database of people for the second person.

11. The method of claim 10, wherein the second person is determined to be a client of the first person for the first project.

12. The method of claim 6, wherein determining the second person associated with the first project comprises the steps of:
determining an email address used by the first person at a given company;
based on the email address used by the first person at the given company, determining an email format for the given company;
using the email format for the company to search the database of people for the second person such that an email address used by the second person has the email format for the given company.

13. The method of claim 12, wherein the second person is determined to be a collaborator of the first person for the first project.

14. The method of claim 6, wherein determining the second person associated with the first project comprises the steps of:
searching the database of projects for a second project, wherein the first person is associated with the first project and with the second project;
based on the second person being associated with the second project, determining the second person to be associated with the first project.

15. The method of claim 14, wherein, based on the second person being associated with the second project, determining the second person to be associated with the first project comprises:
based on the second person being a collaborator of the first person for the second project, determining the second person to be a collaborator of the first person for the first project.

16. The method of claim 6, wherein determining the second person associated with the first project comprises the steps of:
determining an email address used by the first person at a given company;
based on the email address used by the first person at the given company, determining an email format for the given company;
using the email format for the company to search the database of projects for a second project; and
based on the second person being associated with the second project, determining the second person to be associated with the first project;
wherein an email address used by the second person has the email format for the given company.

17. The method of claim 16, wherein the first person is not associated with the second project.

18. The method of claim 16, wherein the second person is determined to be a collaborator of the first person for the first project.

19. A system for use in populating a user profile, the system comprising:
at least one storage medium comprising a database of people, a database of awards, and a database of projects; and
at least one server coupled to the at least one storage medium and operative:
to determine that a first person within the database of people is associated with a given award within the database of awards;
to determine that a first project within the database of projects is associated with the given award within the database of awards; and
to populate the profile for the first person with information associated with the first project.

20. A non-transitory storage medium having software embodied therewith for use in populating a user profile, said software comprising:
software configured:
to determine that a first person within the database of people is associated with a given award within the database of awards;
to determine that a first project within the database of projects is associated with the given award within the database of awards; and
to populate the profile for the first person with information associated with the first project.
